(19) United States
(12) Patent Application Publication
(10) Pub. No.: US 2026/0001745 A1
(43) Pub. Date: Jan. 1, 2026

(54) CRANE WITH A DEVICE FOR RAISING A LOAD

(71) Applicant: Liebherr-Werk Nenzing GmbH, Nenzing (AT)

(72) Inventors: Manuel TORGHELE, Schruns (AT); Richard TORGHELE, Bartholomäberg (AT)

(21) Appl. No.: 19/249,337

(22) Filed: Jun. 25, 2025

(30) Foreign Application Priority Data
Jun. 26, 2024 (DE) 10 2024 118 072.2

(51) Int. Cl. B66C 13/08; B66C 23/36

(52) U.S. Cl. CPC B66C 13/08; B66C 23/36

(57) ABSTRACT

A crane comprises a boom and two independently operable hoisting cable winches, each configured with a hoisting cable guided over the boom. Each hoisting cable carries a load suspension means for fastening a load. The crane comprises a lifting device having an upper part pivotably attached to the boom, and a lower part connected to the upper part pivotably about a horizontal pivot axis, with axes of rotation parallel to the pivot axis. The hoisting cables are each guided over first and second deflection pulleys and attached to the lower part at their free ends. The deflection pulleys and pivot axis are arranged such that, by asynchronous actuation of the hoisting cable winches while performing a pivoting movement of the lower part relative to the upper part, a load connected to both load suspension means can be rotated about a load pivot axis running parallel to the pivot axis.

### CROSS REFERENCE TO RELATED APPLICATION

The present application claims priority to German Patent Application No. 10 2024 118 072.2 filed on Jun. 26, 2024. The entire contents of the above-listed application are hereby incorporated by reference for all purposes.

### TECHNICAL FIELD

The present disclosure relates to a crane, a raising device for such a crane, and to a method for raising a load by means of such a crane.

### BACKGROUND

To raise (i.e. rotate around a horizontal axis of rotation from a horizontal to an upright position) elongated loads such as a tower section, two cranes are usually used in a tandem lift. However, such lifts require precise coordination of the crane movements and are therefore complicated to perform. In addition, not every construction site has two cranes available, which means that a second crane may have to be scheduled especially for such a raising process, which increases the costs of the construction site operation.

### SUMMARY

The object of the present disclosure is to provide a device that allows elongated loads to be raised by means of a single crane.

According to the disclosure, this object is achieved by a crane, a raising device, and a method having the features described herein.

Accordingly, a crane comprising a boom and two hoisting cable winches is proposed. The hoisting cable winches store two hoisting cables and can be operated independently of each other. Each of the hoisting cables carries a load suspension means for attaching a load, for example a hook block, into which the respective hoisting cable is reeved. A load can thus be attached to two attachment points on the two load handling attachments of the hoisting cables and lifted and moved by operating the hoisting cable winches.

According to the disclosure, the crane comprises a raising device for raising a load, which comprises an upper part with first deflection pulleys for guiding the hoisting cables and a lower part with second deflection pulleys for guiding the hoisting cables. The upper part is attached to the boom, while the lower part is not directly connected to the boom, but is pivoted to the upper part. As the names suggest, the lower part sits below the upper part and is therefore closer to the load than the upper part. Optionally, the upper part is pivoted on the boom, for example about a horizontal pivot axis running parallel to the boom luff axis, so that the raising device aligns itself automatically due to gravity. The second deflection pulleys of the lower part have axes of rotation that run parallel to the horizontal pivot axis of the articulated connection between the lower and upper parts. If only the pivot axis is mentioned in the following, this refers to the pivot axis between the lower and upper part.

Each of the two hoisting cables is guided by a first deflection pulley and a second deflection pulley. It is conceivable that the upper part comprises a plurality of first deflection pulleys and/or the lower part comprises a plurality of second deflection pulleys. The hoisting cables are attached to the lower part at their free ends, for example via cable locks, wherein the lower part has appropriate fastening means for this, optionally on its underside facing away from the upper part.

According to the disclosure, the raising device is designed or the deflection pulleys and the pivot axis are arranged in such a way that, by asynchronous actuation of the hoisting cable winches while performing a pivoting movement of the lower part relative to the upper part, a load connected to both load suspension means can be specifically rotated about a load pivot axis running parallel to the pivot axis, i.e. the load can be raised. In other words, when the hoisting cable winches are operated asynchronously, the lower part pivots while the load is being raised.

Asynchronous actuation of the hoisting cable winches is understood here to mean a control system in which the load suspension means of the hoisting cables do not move up or down at the same speed. This can be achieved by driving only one of the two hoisting cable winches to unwind or wind the hoisting cable, while the other hoisting cable winch is not actuated. This means that only one of the load suspension means is moved. Asynchronous movement of the hoisting cable winches can also be achieved by actuating or driving both hoisting cable winches, but rotating them at different speeds in one direction or the other or in different directions. In the latter case, one of the load suspension means is lowered while the other is lifted.

With the raising device, large loads can be raised safely, space-savingly, quickly and cost-effectively with just one crane. The raising device functions independently of the shape of the load. The division into upper and lower parts allows the deflection pulleys, in particular the second deflection pulley, to be arranged in such a way that larger loads can be raised. In particular, the greater the horizontal distance between the second deflection pulleys, the greater the loads that can be rotated. In addition, a multi-part structure of the raising device offers the possibility of modular design and, in particular, the ability to exchange the lower part and thus adapt it to the size of the load to be rotated.

In one possible embodiment, it is provided that the upper part is detachably connected to the lower part and, like the lower part, has fastening elements for fastening the free ends of the hoisting cables. This makes it possible to remove the lower part from the upper part and, in a first configuration, only guide the hoisting cables over the first deflection pulleys in order to then attach the hoisting cables to the upper part at their free ends. This means that the upper part alone can also function as a raising device, in particular for turning shorter loads. To turn larger loads, the upper part is used in a second configuration together with the attached lower part and the hoisting cables are attached to the fastening means on the lower part. Turning larger loads with the attached lower part results in particular from the fact that the second deflection pulleys are spaced further apart than the first deflection pulleys.

In another possible embodiment, it is provided that the upper part comprises exactly two first axes of rotation with first deflection pulleys. Exactly one first deflection pulley or a plurality of first deflection pulleys for multiple reeving of a hoisting cable can be mounted on each first axis of rotation. Optionally, the upper part has exactly two first deflection pulleys and the hoisting cables are reeved between the second deflection pulleys and the load suspension means.

Alternatively or additionally, it may be provided that the lower part comprises exactly two second axes of rotation with second deflection pulleys. Exactly one second deflection pulley or a plurality of second deflection pulleys for multiple reeving of a hoisting cable can be mounted on each second axis of rotation.

Optionally, the second axes of rotation are spaced further apart than the first axes of rotation. This increases the distance between the hoisting cables as soon as they are guided over the second deflection pulleys. This enables larger loads to be lifted if they are horizontally aligned without exceeding a maximum cable angle. In the unloaded state, the first and second axes of rotation optionally form the corners of a trapezoid with parallel upper and lower sides.

According to one embodiment, the upper part has exactly two first deflection pulleys and the lower part has exactly two second axes of rotation, on each of which several deflection pulleys are mounted in order to reeve the hoisting cables several times between the second deflection pulleys and the respective load suspension means (for example hook blocks with a plurality of deflection pulleys).

In another possible embodiment, the raising device comprises at least one limit switch, which is designed to output a signal when a maximum cable angle of a hoisting cable is reached. The at least one limit switch is optionally arranged on the lower part and detects, in particular, a cable angle of a hoisting cable extending from the lower part, i.e. a hoisting cable section between the lower part and the load. By limiting the maximum lateral deflection or spread of the hoisting cables, damage to the hoisting cables can be avoided and a safe lifting process can be ensured. The maximum permissible cable angle depends in particular on the design and dimensions of the raising device and may be less than 45°.

The maximum cable angle, which in particular refers to an angle of deflection of a hoisting cable relative to the vertical, is optionally 20-40°, optionally 25-35°. In one exemplary embodiment, the maximum cable angle may be approx. 30°. The maximum cable angle can refer to a vertical plane that is centred between the second deflection pulleys and runs through the pivot axis.

In another possible embodiment, it is provided that the crane comprises a control system by means of which the hoisting cable winches can be controlled and which is connected to the at least one limit switch in order to receive signals from the latter. The control system is configured to output a control signal to at least one hoisting cable winch when a signal representing the maximum cable angle being reached by a hoisting cable is received from the at least one limit switch, in order to actuate it. In particular, the control system can be configured to stop a current hoisting cable winch movement and/or only allow the hoisting cable to be unwound for at least one of the hoisting cable winches, which reduces the cable angle again. Alternatively or additionally, the control system can be configured to issue a warning when the signal is received from the at least one limit switch, which is shown to the crane operator on a display in a cab, for example, and/or is emitted acoustically. The control system may include one or more processors and a memory coupled to the processor(s). The memory may store instructions which, when executed by the processor(s), cause the control system to perform one or more of the actions described herein. The processor(s), memory, and instructions may be implemented using any suitable combination of hardware, software, and/or firmware, and may be distributed across multiple devices or systems, or integrated into a single unit.

In another possible embodiment it is provided that the at least one limit switch is arranged on the lower part in such a way that its orientation relative to a vertical plane remains constant irrespective of the pivot position of the lower part. As the alignment of the lower part changes during the raising of the load due to the pivoting movement about the pivot axis, the outgoing cable angle can be effectively monitored by maintaining the alignment of the at least one limit switch.

For example, the at least one limit switch is mounted on the lower part via a parallelogram mechanism, wherein the arrangement on or connection to an element of the parallelogram mechanism means that the orientation of the limit switch does not change when the lower part pivots about the pivot axis.

In another possible embodiment, it is provided that the at least one limit switch is arranged on a mount rotatably attached to the lower part, wherein the mount is connected to the upper part via a coupling element. In some examples, the coupling element may be a rigid link or rod, a structural arm, a bar, a mechanical strut, or the like. The coupling element is pivoted to the upper part via a first articulated connection and pivoted to the bracket via a second articulated connection and forms an element of a parallelogram guide. The lower part may comprise a frame, wherein a part of the frame, which in particular extends between the pivot axis and a second deflection pulley, may represent the member of the parallelogram guide extending parallel to the coupling element. The first and second articulated connections, the pivot axis of the bracket and the pivot axis form the articulations of the parallelogram guide. Optionally, the axis of rotation of the mount corresponds to the axis of rotation of a second deflection pulley. Said mount can be a pulley mount, which in turn is rotatably mounted on the lower part, of at least a second deflection pulley.

In another possible embodiment, it is provided that at least one contacting unit is pivoted on the lower part, which is contacted by a hoisting cable at the maximum cable angle and pressed against a switching element of a limit switch, whereby the limit switch is switched and a signal is sent to the control system. Optionally, the contacting unit is contacted and deflected or pivoted by the hoisting cable before the maximum cable angle is reached, wherein the limit switch is switched when the maximum cable angle is reached.

The contacting unit optionally comprises a pivotably mounted roller arm with a roller that can be contacted by the hoisting cable. The roller arm is pivoted by contacting the roller. Optionally, the roller arm is pivoted about the second axis of rotation of a second deflection pulley. For example, the contacting unit also comprises a contacting plate connected to the roller arm, which contacts or switches the switching element of the assigned limit switch at the maximum cable angle.

The roller arm can have a plate with a recess in which a guide pin that cannot be pivoted relative to the limit switch is mounted. If the roller arm is pivoted by the hoisting cable exerting pressure on the roller, the recess moves relative to the guide pin. The recess can be designed as an elongated hole, for example as a curved elongated hole, and serves to guide and hold the roller arm or the contacting plate.

In another possible embodiment, two limit switches are arranged on the lower part, each of which defines a maximum cable angle of one of the hoisting cables. This allows the cable angles of both hoisting cables to be monitored by one limit switch each. The same maximum cable angle is optionally defined for both hoisting cables. Optionally, the limit switches are arranged in the area of the second deflection pulleys, for example on rotatably mounted mounts of the second deflection pulleys.

In another possible embodiment, it is provided that the lower part comprises a substantially triangular frame, at the lower corners of which the second deflection pulleys are arranged and at the upper corner of which the pivot axis is located. In particular, the frame or the connecting lines between the pivot axis and the axes of rotation of the second deflection pulleys form an isosceles triangle. If no load is suspended from the load suspension means, the base of the triangular frame (or the connecting line between the second axes of rotation) is optionally horizontal.

Alternatively or additionally, it can be provided that the upper part is attached to the boom about a pivot axis running parallel to the boom luff axis. This allows the raising device to maintain the same alignment regardless of the luff position of the boom. Optionally, the upper part is attached to a boom head and, in particular, is hinged to an axle on which a plurality of deflection pulleys for deflecting the hoisting cables are rotatably mounted.

In another possible embodiment, it is provided that the lower part comprises a multi-part frame and can be disassembled for transport. The frame parts can be assembled in a transport position with reduced dimensions. The frame parts can be detachably connected to each other using connection means, for example bolt connections. In the simplest case, the frame can comprise two frame parts, wherein optionally a first frame part supports the pivot axis and a second frame part supports the second deflection pulleys.

The multi-part frame also has fastening means for connecting the frame parts in the transport position. In some examples, fastening means may be bolts, screws, hooks, and the like. For example, retaining means for establishing a bolt connection can be arranged on said second frame part, wherein the dismantled first frame part can be bolted to the retaining means of the second frame part via its connection means. This means that the two frame parts remain connected even in the transport position. Of course, the frame can be made up of more than two frame parts. Other retaining means are also conceivable, for example screw connections and/or hook-bolt connections.

In a further possible embodiment, it is provided that the axes of rotation of the first and second deflection pulleys extend parallel to one another and, for example, perpendicular to a luff axis of the boom. As the pivot axis is horizontal, the axes of rotation of all the deflection pulleys of the raising device are also horizontal in this case.

Alternatively or additionally, it may be provided that the raising device has a symmetrical structure in relation to a vertical plane running through the pivot axis. For example, this refers to a case in which no load is attached to the load suspension means and the lower part is therefore not pivoted.

The disclosure also relates to a raising device for a crane. This has all the features that have already been described in relation to the crane according to the disclosure. In other words, the raising device according to the disclosure comprises an upper part with first deflection pulleys, which upper part is attached to the boom for example in a pivoted manner, and a lower part with second deflection pulleys, which lower part is connected to the upper part in a pivoted manner about a horizontal pivot axis and the axes of rotation of which are parallel to the pivot axis, wherein the hoisting cables can each be guided over a first deflection pulley and a second deflection pulley and can be fastened at their free ends to the lower part (appropriate fasteners are attached to the lower part for this purpose), wherein the deflection pulleys and the pivot axis are arranged such that a load connected to both load suspension means can be specifically rotated about a load rotation axis extending parallel to the pivot axis by asynchronous actuation of the hoisting cable winches while performing a pivoting movement of the lower part relative to the upper part. This results in the same properties, features and advantages as already described in relation to the crane according to the disclosure. A repetitive description is therefore omitted at this point. In particular, the raising device according to the disclosure can be designed according to any of the exemplary embodiments described above, in any combination.

The disclosure also relates to a set made up of the raising device according to the disclosure and at least one further lower part, which has a different arrangement, for example a different spacing, of the second deflection pulleys. The lower part of the raising device is detachably connected to the upper part. This makes it possible to replace the lower part as required, wherein a larger or smaller load can be turned due to the different arrangement of the second deflection pulleys. The modular design of the raising device and the possibility of having any number of differently dimensioned lower parts available and adapting the lower part used to the load to be rotated results in a high degree of flexibility and a wide range of loads that can be raised using the crane.

The disclosure also relates to a method for raising a load by means of the crane according to the disclosure. Here too, the same properties, features and advantages arise as already described in relation to the crane according to the disclosure. In the raising method according to the disclosure, the hoisting cable winches are actuated asynchronously (for example, only one of the hoisting cable winches is rotated while the other is stationary, wherein it is also conceivable to rotate the two hoisting cable winches at different speeds in the same direction or to rotate them in different directions), as a result of which the load suspension means move away from each other in a vertical direction and the load is raised about a load pivot axis running parallel to the pivot axis. During the raising process, the lower part rotates relative to the upper part around the horizontal pivot axis.

### BRIEF DESCRIPTION OF THE FIGURES

Further features, details and advantages of the disclosure result from the following exemplary embodiments explained with the help of the figures. In the drawings:

FIG. 1: shows a front view of an exemplary embodiment of the raising device according to the disclosure without a suspended load;

FIG. 2: shows an enlargement of the raising device according to FIG. 1;

FIG. 3: shows a perspective view of a further exemplary embodiment of the lower part;

FIG. 4: shows a perspective view of the second deflection pulleys with a limit switch arrangement according to an exemplary embodiment;

FIGS. 5A-B: shows a side view and a front view, respectively, of an exemplary embodiment of the crane according to the disclosure with a suspended load;

FIGS. 6A-D: show front views of the crane when raising the load; and

FIG. 7: shows a front view of a further exemplary embodiment of the raising device according to the disclosure without a suspended load.

### DETAILED DESCRIPTION

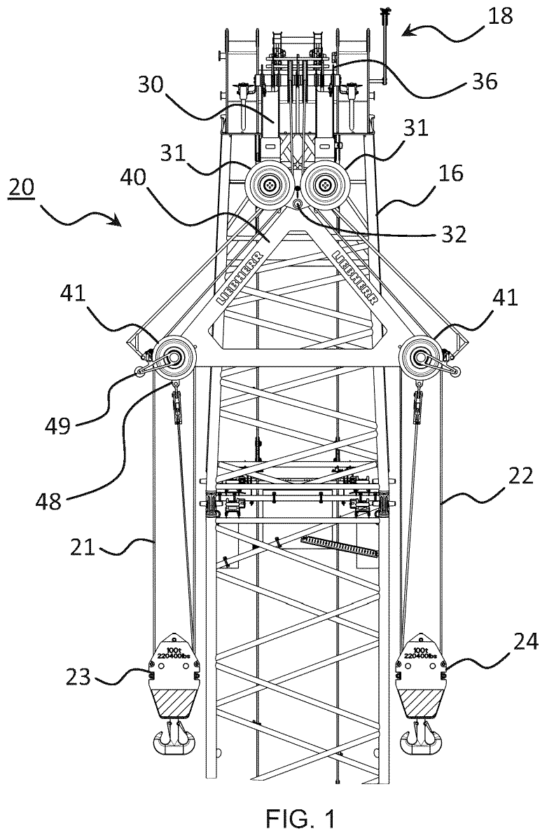

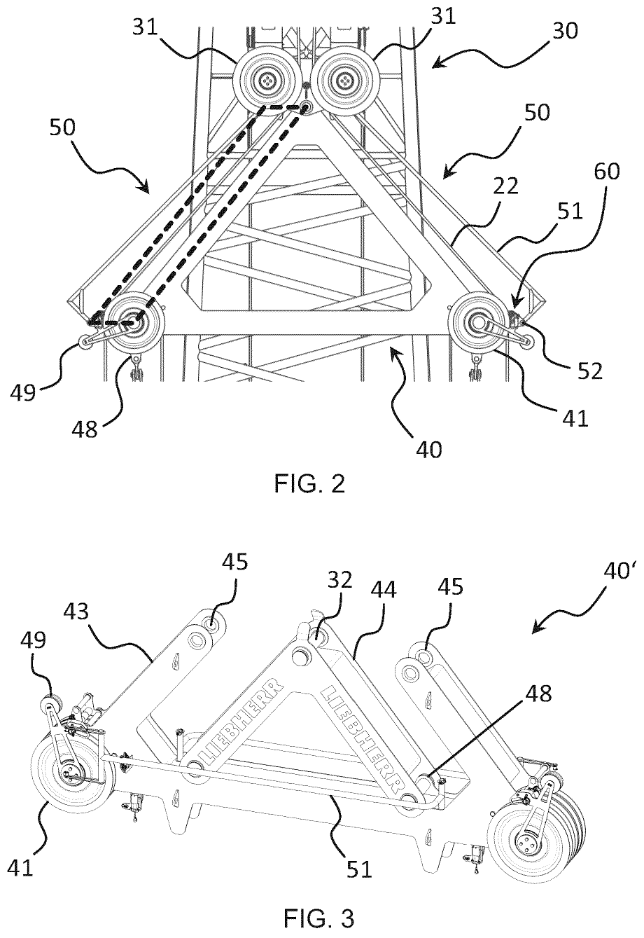

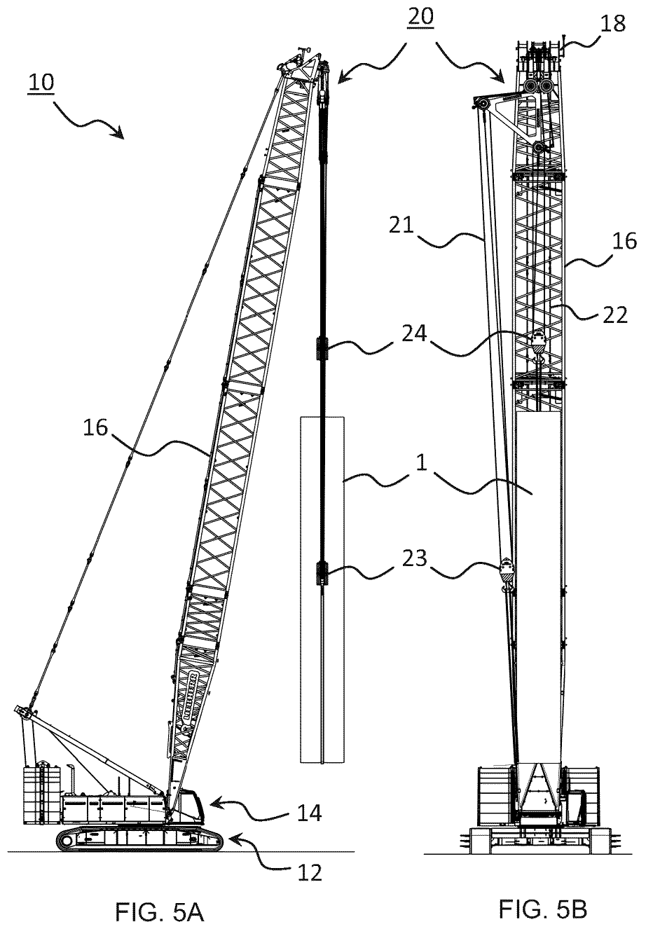

FIG. 1 shows a front view of an exemplary embodiment of the crane 10 according to the disclosure, wherein a section in the area of the boom tip is shown. FIG. 2 shows an enlarged view of the raising device 20. In this exemplary embodiment, the crane 10 is a crawler crane, which is shown in FIGS. 5A-5B in an overall view (FIG. 5A: side view; FIG. 5B: front view). This crane 10 comprises a mobile undercarriage 12 and an upper carriage 14 mounted rotatably on the undercarriage 12, to which the lattice boom 16 is pivoted about a horizontal luff axis.

However, the present disclosure or the raising device 20 according to the disclosure can also be used with other cranes, for example with a mobile crane with a telescopic boom, a mobile crane with a lattice boom or with a stationary crane with a luffing boom. The equipment of the crane, the type of boom, etc. are of no further relevance for the following description of the disclosure, apart from the fact that the crane 10 according to the disclosure has two hoisting cable winches, on which a first hoisting cable 21 and a second hoisting cable 22 are mounted so that they can be wound up and unwound. For example, the hoisting cable winches are controlled independently by a control system.

The crane 10 has a raising device 20, which is mounted on the boom 16 and over which both hoisting cables 21, 22 are guided. In one example, the raising device may be a sheave assembly. By means of this raising device 20, a load 1 (for example a long pipe or the tower or a tower element of a wind turbine) can be raised from a horizontal to a vertical position using only the crane 10. The two hoisting cables 21, 22 each carry a load suspension means 23, 24 for attaching the load 1, which may be hook blocks, for example.

The raising device 20 comprises an upper part 30 connected to the boom 16 and a lower part 40 pivoted about a horizontal pivot axis 32 and connected to the upper part 30. In the exemplary embodiment shown, the pivot axis 32, which can be formed for example by a bolt connection, extends perpendicular to the boom luff axis.

The upper part 30 can be pivoted on a roller axis of a boom head 18 that extends parallel to the boom luff axis. As a result, the upper part 30 or the raising device 20 is pivoted on the boom 16 about a pivot axis extending parallel to the boom luff axis.

The upper part 30 has first deflection pulleys 31, which are mounted next to each other so as to rotate about two first axes of rotation and over which the two hoisting cables 21, 22 are guided. Optionally, the upper part 30 has exactly two first deflection pulleys 31. The lower part 40 has second deflection pulleys 41, which are mounted to rotate about second axes of rotation, which run parallel to the first axes of rotation. In the exemplary embodiment shown, a plurality of second deflection pulleys 41 are provided on each second axis of rotation. The hoisting cables 21, 22 run from the boom head 18 via the first deflection pulleys 31 and then via the second deflection pulleys 41 to the load suspension means 23, 24, wherein the free ends of the hoisting cables 21, 22 are guided back to the raising device 20 and attached to fastening means 48 of the lower part 40. In the exemplary embodiment shown, the hoisting cables 21, 22 are reeved several times between the second deflection pulleys 41 and the load suspension means 23, 24 or hook blocks (alternatively, the hook blocks could have only one deflection pulley).

By actuating the respective hoisting cable winch, the load suspension means 23, 24 of the hoisting cables 21, 22 are moved up or down. Due to the fact that the second axes of rotation of the second deflection pulleys 41 have a greater horizontal distance to each other than the first axes of rotation, the hoisting cables 21, 22 are guided outwards on the lower part 40. The greater the horizontal distance between the second deflection pulleys 41, the greater the loads 1 that can be lifted in a horizontal orientation.

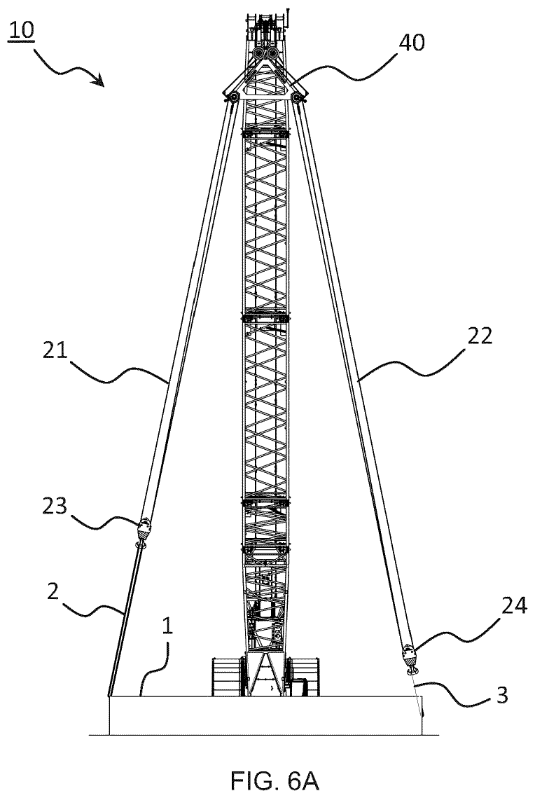

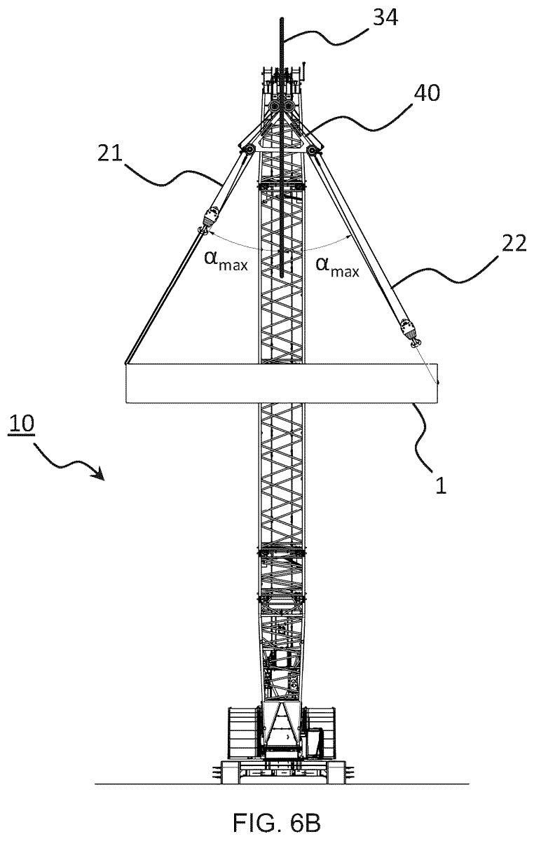

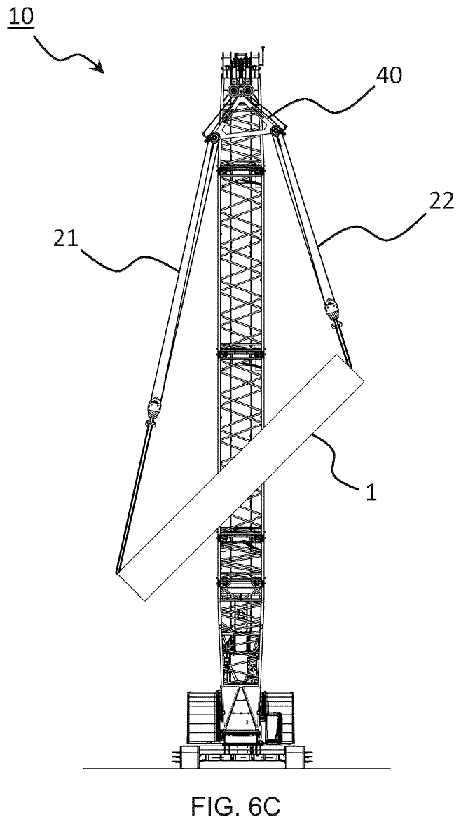

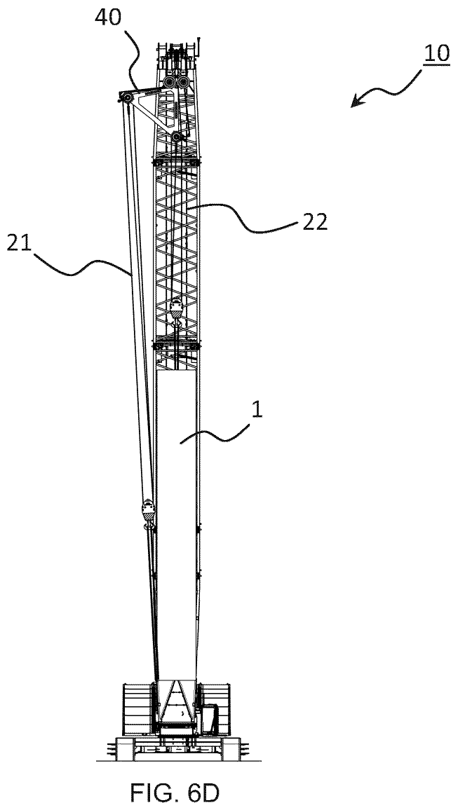

The hoisting cables 21, 22 should not exceed a maximum diagonal pull. For this reason, the raising device 20 according to the disclosure optionally has a device that limits the maximum angle of the hoisting cables 21, 22 relative to the vertical to a defined maximum cable angle αₘₐₓ. Such a diagonal pull results when lifting a load 1 if it is aligned horizontally and exceeds a certain lifting height (see FIG. 6B) or is too long compared to the distance between the second deflection pulleys 41.

For this purpose, limit switches 60 are optionally provided in the area of the second deflection pulleys 41, which are connected to the control system for the hoisting cable winches and emit a signal when a maximum cable angle αₘₐₓ (see FIG. 6B) is reached by one of the hoisting cables 21, 22. The control system is optionally configured so that when such a signal is received by one of the limit switches, it only allows the hoisting cables 21, 22 to be unwound or the load suspension means 23, 24 to be lowered, thereby reducing the cable angle again.

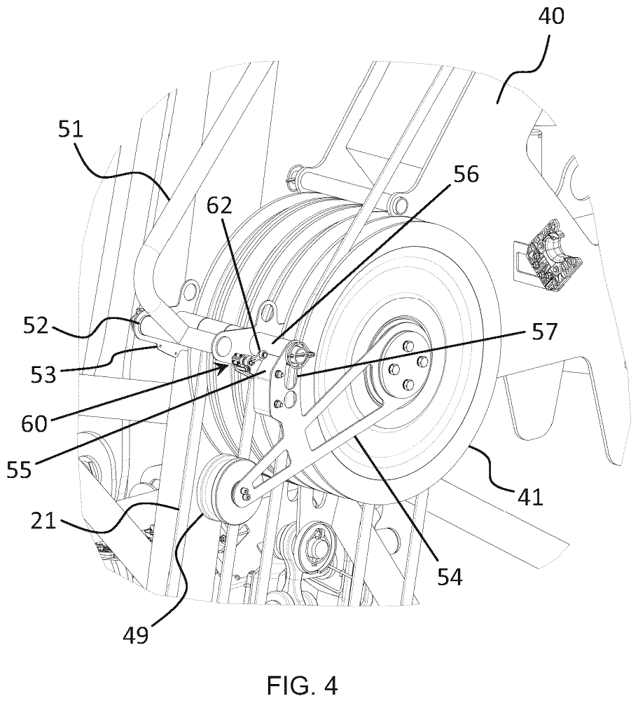

A possible exemplary embodiment of a limit switch arrangement on the lower part 40 is shown in FIG. 4, wherein a perspective view of the second deflection pulleys 41 is shown on one side of the lower part 40, over which the first hoisting cable 21 is guided. In this exemplary embodiment, the limit switch 60 is arranged on a mount 53, which is mounted on the frame 42 of the lower part 40 so as to be rotatable about the second axis of rotation. The fastening means 48 for the hoisting cable 21 can be arranged or formed on the mount 54 (see FIG. 2). The mount 54 may be the roller mount of the second deflection pulley 41.

A roller arm 54 is also mounted on the lower part 40 so as to be rotatable about the second axis of rotation and relative to the mount 53. A pulley 49 is located on the pulley arm 54, which is arranged laterally next to one of the second deflection pulleys 41 in such a way that it is contacted by one of the lifting cable strands from a certain cable angle from diagonally below. A plate with a recess 57 in the form of an elongated hole is arranged on the roller arm 54, in which a guide pin 56 is accommodated. The guide pin 56, the longitudinal axis of which extends parallel to the second axis of rotation in particular, is attached to the mount 53 and is mounted so as to be displaceable in the recess 57. If the hoisting cable 21 presses against the roller 49 during a diagonal pull, the roller arm 54 rotates about the second axis of rotation so that the sheet metal arranged on it is pressed upwards. The guide pin 56 moves downwards relative to this plate along the recess 57.

A contacting plate 55 is arranged on the side of the metal sheet facing the limit switch 60, which optionally forms an incline. The limit switch 60 comprises a pivoted switching element 62, which is located above the contacting plate 55. The switching element 62 can have a roller rolling on the contacting plate, which runs at an angle. If the hoisting cable 21 presses against the roller 49 during an oblique pull, the contacting plate 55 is pushed upwards relative to the switching element 62. If the maximum cable angle αₘₐₓ is reached, the contacting plate 55 pivots the switching element 62 in such a way that the limit switch 60 switches and transmits a corresponding signal to the control system.

In order to monitor the diagonal pull in both directions, such a limit switch arrangement is for example also provided on the other side, i.e. on the second deflection pulleys of the second hoisting cable 22.

To ensure that the limit switch 60 can always switch at the same maximum cable angle αₘₐₓ regardless of the position of the pivoted lower part 40, it may have a constant orientation relative to the vertical. To achieve this, the lower part 40 optionally comprises a parallelogram mechanism 50, which keeps the orientation of the limit switch 60 constant. For this purpose, the lower part 40 can have a coupling element 51 on each side, which is pivoted to the upper part 30 at a first articulated connection (not shown) (this is concealed by the first deflection pulley 31 in FIG. 2) and pivoted to the mount 53 at a second articulated connection 52 visible in FIG. 4.

As schematically indicated with dashed lines in FIG. 2, the two articulated connections, the pivot axis 32 between the upper and lower parts 30, 40 and the respective second axis of rotation each form the four articulations in a parallelogram guide. The element of this parallelogram guide, which is formed by the mount 53 carrying the limit switch 60, retains its alignment when the lower part is pivoted. This also applies for the limit switch 60.

The lower part 40 may have a triangular frame 42, as shown in the figures. In this case, the second deflection pulleys 41 or the second pivot axes can be arranged at the lower corners of the triangle and the pivot axis 32 at the upper tip of the triangle and optionally form an isosceles triangle. The frame 42 can be formed in one piece, as is indicated in the exemplary embodiment of FIGS. 1-2.

Alternatively, the frame 42 can be constructed in several parts. A possible exemplary embodiment of this is shown in a perspective view in FIG. 3. In this case, the frame 42 is constructed in two parts and comprises a first frame part 43, which carries the second deflection pulleys 41, and a second frame part 44, which is detachably connected to the first frame part 43 via connection means 45 (for example bolt connections) and comprises the pivot axis 32. This offers the advantage that the frame parts 43, 44 can be disassembled for transport and connected to each other in a transport position with reduced dimensions, which can be seen in FIG. 3. For this purpose, the first frame part 43 can have corresponding retaining means 48, for example in the form of bolt receptacles, which can be connected to the connection means 45 of the second frame part 44. The coupling elements 51 can also be accommodated in corresponding mounts.

FIGS. 5A and 5B show the crane 10 in a side or front view with a load 1 already raised. It can be seen that the load suspension means 23, 24 can be connected to the ends of the load 1 via slinging means 2, 3 (see FIG. 6A) of different lengths so that the hoisting cable 21 connected to the lower end of the load 1 (after raising) does not need to be unwound as far. However, these slinging means 2, 3, which may be chains or cables, for example, are optional. When the load 1 is raised, the lower part 40 pivots to the side relative to the upper part 30. FIG. 5B shows the end position of the lower part 40.

The raising process is shown in FIGS. 6A-6D with the load 1 in various positions. The crane 10 is shown in a front view. In FIG. 6A, the load 1 is placed horizontally on the floor and the load suspension means 23, 24 are connected to the ends of the load 1 (via the slinging means 2, 3). In this unloaded state, the lower part 40 is not pivoted relative to the upper part 30, so that the lower support of the frame 42, which connects the second deflection pulleys 41 to each other, extends horizontally.

The load 1 is now lifted, wherein the hoisting cable winches are moved synchronously. This maintains the horizontal alignment of the load 1 when it is lifted. The load 1 is lifted until there is sufficient space above the ground to raise it. However, the hoisting cables 21, 22 spread out further and further when the horizontally aligned load 1 is lifted, so that their cable angle to the vertical plane 34, which runs through the pivot axis 32 (shown as a thick black line in FIG. 6B), increases. The maximum cable angle αₘₐₓ is optionally limited by the limit switches 60 as described.

Asynchronous actuation of the hoisting cable winches (for example, the first hoisting cable 21 is unwound while the second hoisting cable 22 is not moved) lowers one of the ends of the load 1 (in FIG. 6C, the end connected to the first hoisting cable 21), so that the load 1 is rotated about a load pivot axis parallel to the pivot axis 32 and thus rises to a vertical position. The lower part 40 pivots to the side. During the raising process, the lower part 40 can pivot first to one side and then (more strongly) to the other (see FIGS. 6C and 6D). FIG. 6D shows the load 1 in the raised state. The vertically aligned load 1 can now be set down at its intended location, wherein the hoisting cable winches are optionally actuated synchronously again.

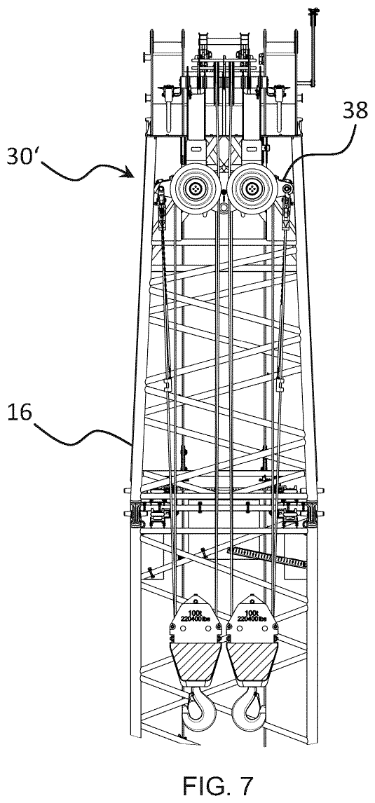

FIG. 7 shows an alternative embodiment of the upper part 30′ of the raising device 20, in which the upper part 30′ also comprises fastening means 38 for fastening the ends of the hoisting cables 21, 22. This means that the lower part 40 can be removed from the upper part 30′ to raise shorter loads 1 and only the upper part 30 with the closely spaced first deflection pulleys 31 can be used as a raising device 20. If larger loads 1 are to be rotated, the distance between the first deflection pulleys 31 is too short. In this case, a corresponding lower part 40 can be attached and the hoisting cables 21, 22 connected to its fastening means 48. A plurality of lower parts with different widths or spacings of the second deflection pulleys 41 can be provided, resulting in a modular expansion option that greatly increases the range of applications.

FIGS. 1-7 are shown approximately to scale. As used herein, the term “approximately” or “substantially” is construed to mean plus or minus two percent of the range unless otherwise specified.

### LIST OF REFERENCE NUMERALS

1 Load
2 Slinging means
3 Slinging means
10 Crane
12 Undercarriage
14 Upper carriage
16 Boom
18 Boom head
20 Raising device
21 First hoisting cable
22 Second hoisting cable
23 First load suspension means
24 Second load suspension means
30 Upper part
30′ Upper part
31 First deflection pulley
32 Pivot axis
34 Vertical plane
36 Connection means
38 Fastening means
40 Lower part
40′ Lower part
41 Second deflection pulley
42 Frame
43 First frame part
44 Second frame part
45 Connection means
46 Retaining means
48 Fastening means
49 Roller
50 Parallelogram mechanism/parallelogram guide
51 Coupling element
52 Second articulated connection
53 Mount
54 Roller arm
55 Contacting plate
56 Guide pin
57 Recess
60 Limit switch
62 Switching element

1. A crane, comprising a boom and two independently operable hoisting cable winches, on each of which a hoisting cable guided over the boom is mounted to be wound up and unwound, wherein each of the hoisting cables carries a load suspension means for fastening a load,
the crane comprising
a raising device for raising the load, which comprises an upper part with first deflection pulleys, which upper part is attached to the boom in a pivoted manner, and a lower part with second deflection pulleys, which lower part is connected to the upper part in a pivoted manner about a horizontal pivot axis and the axes of rotation of which are parallel to the pivot axis, wherein the hoisting cables are each guided over a first deflection pulley and a second deflection pulley and are fastened at their free ends to the lower part, wherein the deflection pulleys and the pivot axis are arranged such that a load connected to both load suspension means can be specifically rotated about a load rotation axis extending parallel to the pivot axis by asynchronous actuation of the hoisting cable winches while performing a pivoting movement of the lower part relative to the upper part.

2. The crane according to claim 1, wherein the upper part is detachably connected to the lower part and has fastening elements for fastening the free ends of the hoisting cables, such that the raising device can be used in a first configuration only with the upper part and hoisting cables fastened to the upper part or in a second configuration with the upper and lower parts and hoisting cables fastened to the lower part.

3. The crane according to claim 1, wherein the upper part comprises exactly two first axes of rotation with first deflection pulleys and/or the lower part comprises exactly two second axes of rotation with second deflection pulleys.

4. The crane according to claim 1, wherein the raising device comprises at least one limit switch arranged on the lower part, which is designed to output a signal when a maximum cable angle of the hoisting cable relative to vertical is reached.

5. The crane according to claim 4, comprising a control system by means of which the hoisting cable winches can be controlled and which is connected to the at least one limit switch, wherein the control system is configured to output a control signal to at least one hoisting cable winch upon receipt of the signal from the at least one limit switch to stop a current hoisting cable winch movement and/or to only allow the hoisting cable to be unwound for at least one of the hoisting cable winches.

6. The crane according to claim 4, wherein the at least one limit switch is arranged on the lower part via a parallelogram mechanism, in such a way that its orientation relative to the vertical remains constant irrespective of the pivot position of the lower part.

7. The crane according to claim 6, wherein the at least one limit switch is arranged on a mount rotatably attached to the lower part, wherein the mount is connected to the upper part via a coupling element, which is pivotably connected to the upper part via a first articulated connection and pivotably connected to the mount via a second articulated connection, wherein the first and second articulated connections, the pivot axis of the mount and the pivot axis form articulations of a parallelogram guide.

8. The crane according to claim 7, wherein the lower part comprises at least one pivotably mounted contacting unit, which is designed such that it is contacted by the hoisting cable at its maximum cable angle and pressed against a switching element of a limit switch.

9. The crane according to claim 4, wherein two limit switches are arranged on the lower part, which in each case define the maximum cable angle of the hoisting cable, wherein the two limit switches are arranged on rotatably mounted mounts of the second deflection pulleys.

10. The crane according to claim 1, wherein the lower part comprises a substantially triangular and isosceles frame, at lower corners of which the second deflection pulleys are arranged and at an upper corner of which the pivot axis is located, and/or wherein the upper part is attached to a boom head of the boom, about a pivot axis extending parallel to a luff axis of the boom.

11. The crane according to claim 1, wherein the lower part comprises a multi-part frame and can be disassembled for transport or assembled in a transport position with reduced dimensions, wherein the multi-part frame has retaining means for connecting the frame parts in the transport position.

12. The crane according to claim 1, wherein the axes of rotation of the first and second deflection pulleys extend parallel to one another and perpendicular to a pivot axis of the boom and/or wherein the raising device has a symmetrical structure with respect to a vertical plane extending through the pivot axis.

13. A raising device for the crane according to claim 1.

14. A set comprising the raising device according to claim 1 and at least one further lower part having a different arrangement, wherein the different arrangement is a different spacing of the second deflection pulleys, wherein the lower part of the raising device is detachably connected to the upper part and can be replaced by the at least one further lower part in order to raise loads of different sizes.

15. A method for raising a load by means of the crane according to claim 1, wherein the hoisting cable winches are actuated asynchronously, whereby the load suspension means move away from one another in the vertical direction and the load is raised about a load rotation axis extending parallel to the pivot axis between the upper and lower parts of the raising device, wherein the lower part rotates relative to the upper part during the raising process.

16. The crane according to claim 3, wherein the second axes of rotation are at a greater distance from each other than the first axes of rotation.

17. The crane according to claim 4, wherein the maximum cable angle relative to vertical is 20-40°.

18. The crane according to claim 17, wherein the maximum cable angle relative to vertical is 25-35°.

19. The crane according to claim 7, wherein the pivot axis of the mount corresponds to the pivot axis of the second deflection pulley.

20. The crane according to claim 8, wherein the contacting unit comprises a pivotably mounted roller arm with a roller that can be contacted by the hoisting cable, and a contacting plate connected to the roller arm for contacting the switching element at the maximum cable angle.
